(19) United States
(12) Patent Application Publication
(10) Pub. No.: US 2004/0138046 A1
(43) Pub. Date: Jul. 15, 2004

(54) Ceramic forming polymer derived ceramic composite and methods

(76) Inventors: Walter J. Sherwood JR., Troy, NY (US); Lynn Tarnowski, Troy, NY (US)

Correspondence Address: HOFFMAN WARNICK & D'ALESSANDRO, LLC, 3 E-COMM SQUARE, ALBANY, NY, 12207

(21) Appl. No.: 10/340,027

(22) Filed: Jan. 10, 2003

(51) Int. Cl. C04B 35/00

(52) U.S. Cl. 501/95.1

(57) ABSTRACT

A ceramic composite having a ceramic coating formed from a ceramic forming polymer of adjustable composition. The ceramic forming polymer is capable of producing a weak interface-type fiber coating for the ceramic composite, resists oxidation and is less expensive to apply. The invention also includes methods of using a ceramic forming polymer to provide fiber coatings tailored to the type of matrix, fiber, or other reinforcement used. The material forms micro-porous and nano-porous coatings on the fibers. The porosity in the coatings provides a low strength interface between the fiber and matrix that imparts the toughness needed in the composite. The material can be provided with controlled ratios of carbon, silicon, oxygen and hyrdrogen to optimize bonding to the fibers, bonding of the matrix to the fiber coating, and environmental protection of the fibers.

### BACKGROUND OF THE INVENTION

1. Technical Field

The present invention relates generally to ceramic composites, and more specifically, to a ceramic forming polymer derived ceramic composite and fiber coating.

2. Related Art

Referring to FIGS. 1 and 2, ceramic composites are conventionally composed of three parts including: a group of fibers 1 or “tows” surrounded by a “weak interface” 2. The fibers are embedded in a ceramic matrix 3 to make the composite. In many coating processes there is also a phenomenon called “bridging” 4 in which the coating bonds the fibers together.

Fiber-reinforced ceramic-matrix composites, unlike typical polymer composites, require a weak fiber to matrix interfacial bond strength to prevent catastrophic failure from propagating matrix cracks through the fiber reinforcement. In particular, the interface must provide sufficient fiber/matrix bonding for effective load transfer, but must be weak enough to de-bond and slip in the wake of matrix cracking while leaving the fibers to bridge the cracks and support the far-field applied load. In other words, the interface material provides “crack-stopping” by allowing the fiber to slide in the interface coating at the fiber-coating interface 6. In some cases, the coated fiber can move in the matrix by sliding at the coating-matrix interface 7. In most cases, however, the coating material itself is designed to be of much lower strength than either the fiber or the matrix. This situation has historically limited the choice of materials. Typically, the fiber-matrix interface is provided as a pyro-carbon, boron nitride, or a duplex coating having carbon or boron nitride over-coated with silicon carbide.

The coatings are usually applied by a chemical vapor deposition (CVD) process. For example, the CVD process can produce oxide or non-oxide (and carbon) coatings. However, the CVD process is complex and expensive. As a result, it is not unusual for the cost of coating fiber cloth to be significantly more expensive than the cloth itself. Another disadvantage of the CVD process is that control of the coating's thickness varies over large fabric areas. Ceramic forming sol-gel precursors have also been used to form the boron nitride or oxide fiber coatings. However, the sol-gel process, while not expensive, produces primarily oxide materials.

The above described fiber coatings such as carbon and boron nitride have demonstrated the desired mechanical characteristics necessary to enhance the composite strength and toughness. However, the utility of these composites is severely limited by their susceptibility to oxidation brittleness and strength degradation at or beyond the matrix cracking stress point and subsequent exposure to high-temperature oxidation. The accelerated environmental degradation of the fiber coating occurs at elevated temperatures in air following the onset of matrix cracking.

In view of the foregoing, there is a need in the art for a material to produce weak interface type fiber coating that is oxidation resistant and less expensive to apply.

### SUMMARY OF THE INVENTION

The invention includes a ceramic composite formed using a non-cyclic ceramic-forming polymer of adjustable composition capable of producing a weak interface-type fiber coating for the ceramic composite. The fiber coating resists oxidation and is less expensive to apply. The invention also includes methods of forming a ceramic composite using a ceramic forming polymer to provide fiber coatings tailored to the type of matrix, fiber, or other reinforcement used. The ceramic forming polymers can be applied by spraying, dipping, or vacuum infiltration as opposed to chemical vapor deposition. The material forms micro-porous and nano-porous coatings on the fibers. The porosity in the coatings provides a low strength interface between the fiber and matrix that imparts the toughness needed in the composite. The material can be provided with controlled ratios of carbon, silicon, oxygen and hydrogen to optimize bonding to the fibers, bonding of the matrix to the fiber coating, and environmental protection of the fibers. Further, the invention permits the coating of fiber tows, fiber cloth, woven fiber preforms, chopped fiber preforms or felts, whiskers, filaments, or other types of reinforcement, including particulate, in a much simpler manner at significantly lower cost.

The advantages of ceramic forming polymers as interface coatings include: ease of application, controllable coating thickness, and the ability to easily change the coating behavior by modifying the polymer. Additional benefits include substantial reduction in application costs, and incorporation of the coating step directly into the composite fabrication process when a standard polymer infiltration and pyrolysis process is used.

A first aspect of the invention is directed to a method of forming a ceramic composite, the method comprising the steps of: providing a fiber material; coating the fiber material with a non-cyclic ceramic forming polymer; and curing the non-cyclic ceramic forming polymer.

A second aspect of the invention includes a ceramic composite comprising: a fiber material; and a ceramic coating over the fiber material, the ceramic coating formed from a non-cyclic ceramic forming polymer.

A third aspect of the invention is directed to a method of forming a ceramic composite, the method comprising the steps of: providing a fiber material; coating the fiber material with a ceramic forming polymer including carbon, silicon and oxygen; and curing the ceramic forming polymer.

A fourth aspect of the invention is directed to a ceramic composite comprising: a fiber base material; and a ceramic coating formed from a ceramic forming polymer including carbon, silicon and oxygen.

The foregoing and other features of the invention will be apparent from the following more particular description of embodiments of the invention.

### BRIEF DESCRIPTION OF THE DRAWINGS

The embodiments of this invention will be described in detail, with reference to the following figures, wherein like designations denote like elements, and wherein:

FIG. 1 shows a conventional ceramic composite.

FIG. 2 shows a conventional ceramic composite.

FIG. 3A shows a ceramic composite according to one embodiment of the invention.

FIG. 3B shows a ceramic composite according to another embodiment of the invention.

FIG. 4 shows the chemical structure of a branched silicon oxycarbide precursor.

FIG. 5 shows the chemical structure of a linear silicon oxycarbide precursor.

FIG. 6 shows the chemical structure of a high yield meltable solid silicon oxycarbide precursor.

FIG. 7 shows the chemical structure of a carbon-rich silicon carbide fiber precursor.

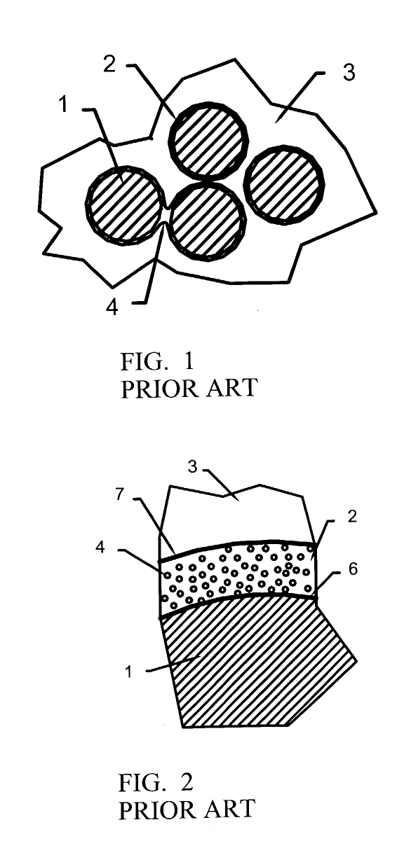

### DETAILED DESCRIPTION OF THE INVENTION

The description includes the following subtitles for clarity purposes only: I. Overview, II. Fiber Material, III. Ceramic Forming Polymer Coating, IV. Curing, and V. Other Processing.

I. Overview

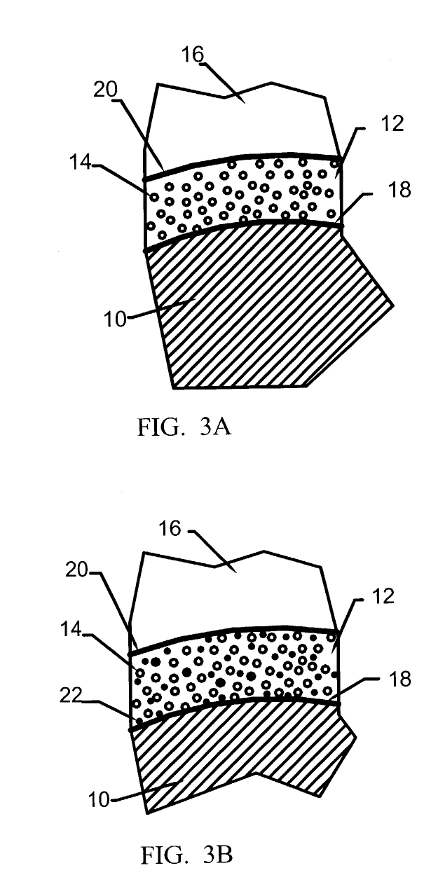

Referring to FIGS. 3A-B, the invention includes a ceramic composite comprising: a fiber material 10, and a ceramic coating 12 over fiber material 10 where the ceramic coating is formed from a non-cyclic ceramic forming polymer. (Note: FIG. 3A appears similar to FIG. 2, however, the materials used in FIG. 3A are according to the invention.) A ceramic matrix 16 is provided over ceramic coating 12 and fiber material 10. The non-cyclic ceramic forming polymer may be selected from the group comprising: polycarbosilane, hydridopolycarbosilane, polyhydridosilane, polyhyridosilazane, polysiloxane, polysesquilsiloxane and high char yield hydrocarbon polymer. Ceramic composite 12 may include carbon, silicon and oxygen. Ceramic coating 12 has a plurality of nanoscale pores 14 that impart a lower strength to the coating relative to fiber material 10 and matrix 16. As a result, the ceramic-matrix composite provides a weak fiber material 10 to matrix 16 interfacial bond strength and prevents catastrophic failure from propagating matrix cracks. In particular, the composite provides sufficient fiber/matrix bonding for effective load transfer, but is weak enough to de-bond and slip in the wake of matrix cracking while leaving fiber material 10 to bridge the cracks and support the far-field applied load. The interface material provides “crack-stopping” by allowing the fiber to slide in the interface coating at the fiber material-coating interface 18. In some cases, fiber material 10 can move in matrix 16 by sliding at the coating-matrix interface 20.

Methods of forming the ceramic composite include: providing a fiber material; coating the fiber material with one of the above-described ceramic forming polymers; and curing the ceramic forming polymer.

II. Fiber Material

Fiber material 10 may take a variety of forms. For instance, fiber material 10 may take the form of one of: a fiber tow, fiber cloth, a woven fiber preform, a chopped fiber preform, a chopped fiber felt, whiskers, fiber filaments, and a particulate or platelet. Material may be made of, for example, carbon fiber, graphite fiber and ceramic fiber.

If carbon fiber is selected, in one embodiment, the carbon fiber may be an acrylic-derived fiber based on polyacrylnitrile (PAN) such as those designated T-300, AS-4, T-650, T-700, and T-1000 available from, for example, Toray or Amoco. In another embodiment, material may include carbon fibers that are pitch-based carbon fibers such as those designated P-25, P-55, P75, K-700, K-1100, available from, for example, Conoco. In another embodiment, the fibers may be a non-oxide fiber chosen from the group comprising: silicon carbide, near-silicon carbide, silicon borocarbide, silicon carbonitride, or silicon nitrocarbide (SiNC) fibers. Commercial examples of these materials include: Nicalon, Hi-Nicalon or Hi-Nicalon type-S available from Nippon Carbon; Sylramic or Sylramic treated to form a boron-nitride (BN) interface available from COI Ceramics; Tyranno LOX E, Tyranno ZMI or Tyranno SA-type available from UBE Ltd.

In another embodiment, fiber material 10 may be chosen from the group comprising: refractory metal, refractory metal carbide, refractory metal boride, or refractory metal nitride fibers. Illustrative fibers of this type include: hafnium carbide, hafnium nitride, hafnium diboride, rhenium, tantalum, tantalum carbide, or tantalum nitride.

In another embodiment, fiber material 10 may include oxide fiber chosen from the group comprising: alumina, mullite and aluminosilicate. Commercial examples of these fibers include Nextel 312, Nextel 312BN, Nextel 440, Nextel 610 and Nextel 720 available from 3M Corp.

III. Ceramic Forming Polymer Coating

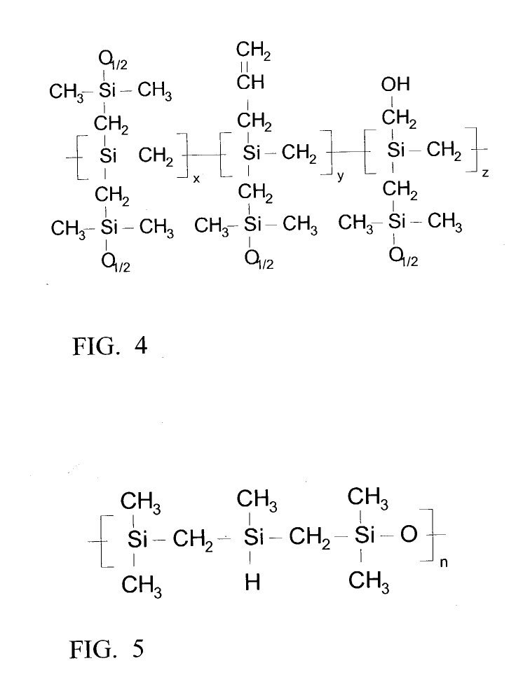

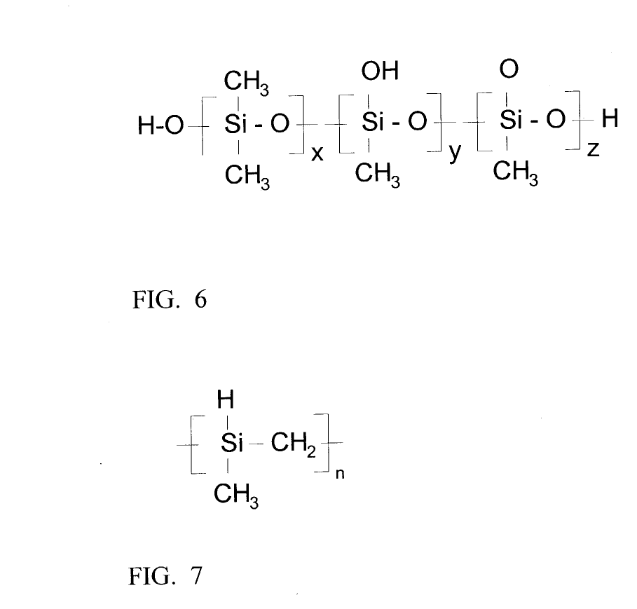

The ceramic forming polymer material is specially formulated to provide the desired coating properties on the particular fiber material chosen. The material may be of the following types: silicon oxycarbides (SOC), carbon-rich silicon carbides, carbon-rich SOC, carbon forming polymers, or mixtures of the aforementioned polymers. As discussed above, in general terms the ceramic forming polymer may be designated as a non-cyclic ceramic forming polymer and/or as containing carbon, silicon, oxygen and hydrogen. More particularly, in one embodiment, the ceramic forming polymer may be selected from the group comprising: polycarbosilane, hydridopolycarbosilane, polyhydridosilane, polyhyridosilazane, polysiloxane, polysesquilsiloxane and high char yield hydrocarbon polymer. In addition, ceramic forming polymer further may also include boron at no less than 0.25% by weight and at no greater than 5% by weight. Illustrative chemical structures are shown in FIGS. 4-6. FIG. 4 shows the chemical structure of a branched SOC 500B precursor that forms a porous carbon-rich oxycarbide ceramic coating 12. FIG. 5 shows the chemical structure of a linear SOC 500L precursor that forms a porous oxycarbide ceramic coating 12. FIG. 6 shows the chemical structure of a high yield meltable solid SOC that forms a very high temperature stable, low carbon, porous oxycarbide ceramic coating 12. (In FIG. 6, x=0.02-0.08 parts, y=0.08-0.20 parts, and z=0.72-0.90 parts). FIG. 7 shows the chemical structure of a carbon-rich silicon carbide fiber that forms a carbon-rich silicon carbide coating 12.

Many of the above-described polymers can be used to coat fiber material without further preparation. For example, the linear oxycarbide precursor (FIG. 5) can be used as is. However, some of the above-mentioned polymers, e.g., the high yeld meltable SOC (FIG. 6), are solids that must be dissolved in a solvent to enable coating. Still others are high yield liquids, e.g., the branched oxycarbide SOC (FIG. 4), that require dissolving in a solvent to enhance coating uniformity on fiber material. Where a solvent is required, the solvent may be selected from aromatic hydrocarbons or aliphatic hydrocarbons such as: tetrahydrofuran, hexane, heptane, octane, ether, acetone, ethanol, methanol, toluene and isopropyl alcohol. The type of solvent used will vary depending on the polymer. For instance, typically ethanol, toluene, or acetone are used with SOCs. Similarly, hexane, tetrahydrofuran, or toluene are preferred for carbon-rich SOCs, carbon-rich silicon carbides, or carbon polymers.

The amount of polymer required is chosen such that the resulting coating on fiber material 10 has a thickness of no less than 0.005 micron and no greater than 3 microns depending on the type and diameter of the fiber. Preferably, the thickness is no less than 0.25 microns and no greater than 0.6 microns. It has been discovered that these thicknesses improve the oxidation resistance of fiber material 10 in matrix 16, and improves the toughness of ceramic matrix, glass matrix, and organic polymer matrix composites. In most cases, these thicknesses result in the mass of the polymer needed for coating a given fiber being between 5% and 25% of the fiber mass (for carbon, silicon carbide, silicon nitride, silicon carbonitride, alumina, and aluminosilicate fibers). Denser fibers or whiskers such as hafnium carbide or hafnium nitride, would require polymer masses that are roughly 1% to 5% of the fiber masses.

The ceramic forming polymer is dissolved in sufficient solvent, when necessary, to permit uniform distribution of the polymer throughout fiber material 10. Typically, the ceramic forming polymer is between 50% and 250% of the mass of the composite depending upon the application method. Lower solvent levels would be used for dip-coating of fabric, thin woven performs, or tows, while larger solvent levels would be used for spraying or coating thick felts or dense preforms.

The actual coating process may include spraying, dipping, soaking and vacuum infiltrating the ceramic forming polymer onto fiber material 10. In one embodiment, the solvent may be rapidly driven off by flowing warm air to minimize wicking which could decrease the uniformity of the fiber coating.

In an alternative step, fiber material 10 may be heated to at least 1600° C. and no greater than 2200° C. for at least one hour and no more than two hours prior to the coating step to aid in the uniform distribution of the polymer.

IV. Curing

Once the coating has been applied and the solvent removed, the coating is thermally cured, i.e., by heating. Depending on the polymer type, the curing atmosphere may occur in an atmosphere containing an inert gas (e.g., nitrogen, argon, helium) and may include an active gas such as oxygen, hydrogen, air and ammonia. Where an active gas is provided, the active gas makes up no less than 2% by volume and no more than 50% by volume of the atmosphere, with a preferred range of approximately 25%-40%. Where hydrogen is used, the atmosphere includes no less than 2% by volume hydrogen and no more than 10% by volume hydrogen, and preferably between 4%-7%.

The curing of the coating materials is accomplished in a number of ways depending on the ceramic forming polymer used: For the branched and linear SOCs shown in FIGS. 4 and 5 and the carbon-rich silicon carbide in FIG. 7, curing is done by heating (e.g., in flowing inert gas) at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. (also in inert gas or in selected active gases noted previously) with a 0.5-2 hour hold at that temperature will cure the fiber coating resin. For the high yeld meltable SOC polymer in FIG. 6, curing is accomplished by heating in flowing inert gas at a nominal rate of approximately 2° C. per minute up to approximately 100° C., with a hold at approximately 100° C. for approximately 1 hour per inch of thickness of fiber material 10. Further heating at 0.5-1° C. per minute to 150-250° C. (e.g., in air) with a one to four hour hold at that temperature will cure the fiber coating polymer.

After the above processing, coating 12 is fired in an inert gas at increments of approximately 2° C. per minute up to a temperature of 850-1150° C. and held for one hour at the temperature to convert the polymer to ceramic. Multiple coating cycles (with the same or different polymers) can be used to produce a multi-layer interface coating such as may be needed for densification of the composite by infiltration with molten silicon or other metals such as aluminum.

The polymer in FIG. 6 forms a ceramic composite similar to that shown in FIG. 3A with a large number of nano-scale pores 14 in fiber coating 12. The coating will crack between pores 14 to provide the weak interface. When used with certain carbon fibers, ceramic coating 12 will also fail at fiber material-coating interface 18. The polymers shown in FIGS. 4, 5 and 7 typically form a coating similar to the concept shown in FIG. 3B where ceramic coating 12 includes both pores 14 and carbon rich areas 22 that provide a weak interface and a source of oxygen absorbing media (the carbon rich areas) to provide an interface that protects fiber material 10 more effectively in an oxidizing environment.

V. Other Processing

Once the fiber coating has been applied, further processing/densification of the ceramic composite may be accomplished by forming a matrix 16 of ceramic or metal between the coated fibers to increase the density of the composite. In one embodiment, the density in increased by infiltrating the ceramic preform or fibers with one or more types of ceramic forming polymers and proceeding through one or more curing and pyrolysis cycles. The infiltrating ceramic forming polymer may be chosen from, for example, a silicon carbide forming polymer, silicon nitride (SiN) forming polymer, silicon nitrocarbide (SiNC) forming polymer, silicon carbonitride (SiCN) forming polymer and SOC forming polymer. Silicon carbide is available from Starfire Systems, Inc.; SiN is available under the trade name HPZ from COI Ceramics, Inc.; SiNC materials is available from Matech/Global Strategic Materials; SICN under the trade name “Ceraset” is available from Kion Corporation; and SOC polymer is available from COI Ceramics, Inc, Honeywell, Starfire Systems Inc. or Matech/Global Strategic Materials.

In another embodiment, increasing the density of the ceramic composite may be completed by infiltrating the composite with one of a carbon forming material and a molten silicon or another molten metal. In another embodiment, the density of the ceramic composite is increased by chemical vapor infiltrating with one of carbon, graphite and silicon carbide.

### EXAMPLE 1

### Coating Polyacronitrile-based Carbon Fibers

A 50 gram polyacronitrile (PAN) based carbon fiber disk preform is heat treated by heating in inert gas to 1600° C.-1800° C. for 2 hours. An amount of oxycarbide such as Starfire System's silicon oxycarbide (SOC) 35A (FIG. 6) may be used for the ceramic coating. As an alternative, other silicon oxycarbide such as those shown in FIGS. 4 and 5 may be used. In any case, an amount of polymer roughly equal to 18%-22% of the mass of the preform is weighed out on, for example, a three-place analytical balance. An amount of ethyl alcohol, or toluene roughly equal to 150% to 200% of the mass of the preform is weighed out. The polymer is dissolved in the solvent by, for example, stirring in a beaker or flask using a magnetic driven stirrer driving a polytetrafluoroethylene (PTFE) coated stir bar. The polymer is slowly added to the solvent while stirring until all is added. The solution is stirred until all the polymer is dissolved and the solution becomes clear, which may take, for example, 15 minutes to 1 hour. The preform is placed in a tub and the polymer solution is then poured over the preform. The coated preform is then placed into a vacuum or inert gas oven to remove and recover the solvent and cure the polymer. In this case, the curing atmosphere will be air, although nitrogen can also be used. The heating occurs at an incremental rate of approximately 2° C. per minute up to approximately 100° C., with a hold at approximately 100° C. for approximately 1 hour per inch of thickness of fiber material 10. Further heating at 0.5-1° C. per minute up to 150-250° C. (e.g., in air) with a one to four hour hold at that temperature will cure the fiber coating polymer. Following the cure cycle, the coated preform is fired in inert gas at increments of 2° C. per minute up to 850-1150° C. and held at temperature for approximately one hour to convert the polymer coating to ceramic. Once cool, the preform is ready for rough machining to near net shape and/or for infiltration with the matrix material.

### EXAMPLE 2

### Coating Near-stoichiometric Silicon Carbide Fibers

A square foot of cloth composed of near-stoichiometric silicon carbide fiber such as Sylramic, or Tyranno SA, or Hi-Nicalon type-S is first desized (the organic coating needed to allow weaving the fibers) by heating to 450-600° C. in air or to 800° C. in inert gas. An amount of oxycarbide forming polymer such as Starfire System's SOC 500L (FIG. 5), SOC 500B (FIG. 4) or carbon rich polycarbosilane ceramic forming polymer roughly equal to 8-11% of the mass of the cloth is weighed out on a three-place analytical balance. An amount of hexane, or tetrahydrofuran approximately equal to 100%-150% of the mass of the cloth is weighed out. The polymer is dissolved in the solvent by stirring in a beaker or flask using a magnetic driven stirrer driving a PTFE-coated stir bar. The polymer is slowly added to the solvent while stirring until all is added. The solution is stirred until all the polymer is dissolved and the solution becomes clear, e.g., approximately 15 minutes to 1 hour. The fabric is placed in an aluminum foil boat and the polymer solution is then poured over the cloth. Alternatively, for longer rolls of fabric, the cloth can be pulled through a trough containing the polymer solution. Next the cloth is run though rollers to remove excess liquid and is then passed over flowing warm air to remove the solvent. In this case, the coated fabric is placed into a vacuum or inert gas oven to remove and recover the solvent and cure the polymer. In this example, the curing atmosphere is nitrogen, although air can be used. The heating process may include: heating (e.g., in flowing inert gas) at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. (also in inert gas or in selected active gases noted previously) with a 0.5-2 hour hold at that temperature will cure the fiber coating resin. Following the cure cycle, the coated preform is fired in inert gas at increments of 2° C. per minute up to 850-1150° C. and held at temperature for approximately one hour to convert the polymer coating to ceramic. Once cool, the fabric is ready to be stacked up to form a laminated preform prior to infiltration with the matrix material.

### EXAMPLE 3

### Coating Silicon Oxycarbide (Si—C—O) Or Carbon-rich Silicon Carbide Fibers

A 50 gram woven preform composed of Hi-Nicalon, Ceramic Grade Nicalon, Tyranno LOX-M, Tyranno LOX-E or ZMI fiber is first desized by heating to 450-600° C. in air or to 800° C. in inert gas. An amount of SOC such as the polymers in FIG. 4 or 5 roughly equal to 8-25% of the mass of the preform is weighed out on a three-place analytical balance. An amount of toluene solvent roughly equal to 75%-150% of the mass of the preform is weighed out. The polymer is dissolved in the solvent by stirring in a beaker or flask using a magnetic driven stirrer driving a PTFE-coated stir bar. The polymer is slowly added to the solvent while stirring until all is added. The solution is stirred until all the polymer is dissolved and the solution becomes clear, e.g., approximately 15 minutes to 1 hour. The preform is placed in an aluminum foil boat and the polymer solution is then poured over the preform. The coated preform is then placed into a vacuum or inert gas oven to remove and recover the solvent and cure the polymer. Depending on the coating polymer type, the curing atmosphere will be either air or nitrogen. The heating process may include: heating (e.g., in flowing inert gas) at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. (also in inert gas or in selected active gases noted previously) with a 0.5-2 hour hold at that temperature will cure the fiber coating resin. Following the cure cycle, the coated preform is fired in inert gas at increments of 2° C. per minute up to 850-1150° C. and held at temperature for approximately one hour to convert the polymer coating to ceramic. Once cool, the preform is ready for rough machining to near net shape and/or for infiltration with the matrix material.

### EXAMPLE 4

### Coating Oxide Fibers

An area of cloth (e.g., a square foot) composed of oxide-based fibers such as Nextel 312 (aluminosilicate with boron), Nextel 440 (non-stoichiometric mullite), Nextel 720 (near stoichiometric mullite), Nextel 610 (alumina), Silica, or Saffil (alumina) is first desized by heating to 450-600° C. in air or to 800° C. in inert gas. An amount of SOC such as Starfire SOC 500L (FIG. 5) and carbon forming polymers (e.g., Zeco-11), mixed in a 50-50 ratio, are weighed out on a three-place analytical balance to form a total mass equal to roughly 20% of the mass of the cloth. An amount of tetrahydrofuran or toluene solution roughly equal to 100%-150% of the mass of the cloth is also weighed out. The polymer is dissolved in the solvent by stirring in a beaker or flask using a magnetic driven stirrer driving a PTFE-coated stir bar. The polymer is slowly added to the solvent while stirring until all is added. The solution is stirred until all of the polymer is dissolved and the solution becomes clear, e.g., approximately 15 minutes to 1 hour. The fabric is placed in an aluminum foil boat and the polymer solution is then poured over the cloth. Alternatively, for longer rolls of fabric, the cloth can be pulled through a trough containing the polymer solution. Next, the cloth is run though rollers to remove excess liquid and is then passed over flowing warm air to remove the solvent. In this case, the coated fabric is placed into a vacuum or inert gas oven to remove and recover the solvent and cure the polymer. In this example, the curing atmosphere is nitrogen, although air can be used. The heating process may include: heating at an incremental rate of approximately 2° C. per minute up to approximately 100° C., with a hold at approximately 100° C. for approximately 1 hour per inch of thickness of fiber material 10. Further incremental heating at 0.5-1° C. per minute to approximately 200-400° C. with a 0.5-2 hour hold at that temperature will cure the fiber coating resin. Following the cure cycle, the coated preform is fired in inert gas at increments of 2° C. per minute up to 850-1150° C. and held at temperature for approximately one hour to convert the polymer coating to ceramic. Once cool, the fabric is ready to be stacked up to form a laminated preform prior to infiltration with the matrix material.

The processes described in the above examples could also be easily modified within the scope of this invention to coat fiber cloth, fiber tows, chopped fibers, whiskers, or other fiber-based material.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention as defined in the following claims.

What is claimed is:

1. A method of forming a ceramic composite, the method comprising the steps of:
providing a fiber material;
coating the fiber material with a non-cyclic ceramic forming polymer; and
curing the non-cyclic ceramic forming polymer.

2. The method of claim 1, wherein the non-cyclic ceramic forming polymer is selected from the group comprising: polycarbosilane, hydridopolycarbosilane, polyhydridosilane, polyhyridosilazane, polysiloxane, polysesquilsiloxane and high char yield hydrocarbon polymer.

3. The method of claim 2, wherein the non-cyclic ceramic forming polymer further includes boron at no less than 0.25% by weight and at no greater than 5% by weight.

4. The method of claim 2, wherein the non-cyclic ceramic forming polymer has a thickness of no less than 0.005 micron and no greater than 3 microns.

5. The method of claim 4, wherein the thickness is no less than 0.25 microns and no greater than 0.6 microns.

6. The method of claim 1, wherein the non-cyclic ceramic forming polymer includes carbon, silicon, and oxygen.

7. The method of claim 6, wherein the fiber material is heated to at least 1600° C. and no greater than 2200° C. for at least one hour and no more than two hours prior to the coating step.

8. The method of claim 1, further comprising the step of dissolving the non-cyclic ceramic forming polymer in a solvent prior to the coating step.

9. The method of claim 8, wherein the solvent is selected from the group comprising: tetrahydrofuran, hexane, heptane, octane, ether, acetone, ethanol, methanol, toluene and isopropyl alcohol.

10. The method of claim 1, wherein the fiber material is selected from the group comprising carbon fiber, graphite fiber and ceramic fiber.

11. The method of claim 10, wherein the carbon fiber is based on polyacrylnitrile (PAN).

12. The method of claim 10, wherein the fiber material includes fibers that are pitch-based carbon fibers.

13. The method of claim 10, wherein the carbon fiber is a non-oxide fiber chosen from the group comprising: silicon carbide, near-silicon carbide, silicon borocarbide, silicon carbonitride, or silicon nitrocarbide (SiNC) fibers.

14. The method of claim 10, wherein the fiber material is chosen from the group comprising: refractory metal, refractory metal carbide, refractory metal boride, or refractory metal nitride fibers.

15. The method of claim 10, wherein the fiber material includes oxide fiber and is chosen from the group comprising: alumina, mullite and aluminosilicate.

16. The method of claim 1, wherein the curing step occurs in an atmosphere containing an inert gas.

17. The method of claim 16, wherein the atmosphere further includes at least one active gas chosen from the group comprising: oxygen, hydrogen, air, or ammonia.

18. The method of claim 17, wherein the active gas makes up no less than 2% by volume and no more than 50% by volume of the atmosphere.

19. The method of claim 17, wherein the atmosphere includes no less than 2% by volume hydrogen and no more than 10% by volume hydrogen.

20. The method of claim 1, wherein the curing step includes heating the fiber material and the non-cyclic ceramic forming polymer.

21. The method of claim 20, wherein when the ceramic forming polymer is one of a branched silicon oxycarbide, a linear silicon oxycarbide and a carbon-rich silicon carbide, the heating step includes heating:
a) at an incremental rate of approximately 2° C. per minute to a temperature of approximately 100° C. with a hold at 100° C. for approximately one hour per inch of thickness of the fiber material; and
b) at an incremental rate of no less that 0.5° C. per minute and no greater than 1° C. per minute up to a temperature of no less than 200° C. and no greater than 400° C. with a hold at the temperature of no less than half hour and no greater than a two hours.

22. The method of claim 21, further comprising the step of heating in an inert gas to a second temperature of no less than 850° C. and no greater than 1150° C. with a hold at the second temperature for approximately one hour.

23. The method of claim 20, wherein when the ceramic forming polymer is a high yeld meltable SOC polymer, the heating step occurs in an inert gas and includes heating:
a) at an incremental rate of approximately 2° C. per minute up to 100° C. with a hold at approximately 100° C. for approximately one hour per inch of thickness of the fiber material; and
b) at an incremental rate of no less that 0.5° C. per minute and no greater than 1° C. per minute up to a temperature of no less than 150° C. and no greater than 250° C. with a hold at the temperature of no less than one hour and no greater than four hours.

24. The method of claim 23, further comprising the step of heating in an inert gas to a second temperature of no less than 850° C. and no greater than 1150° C. with a hold at the second temperature for approximately one hour.

25. The method of claim 1, further comprising the step of increasing the density of the ceramic composite by one or more cycles of infiltrating with a ceramic forming polymer, curing, and pyrolyzing to form the ceramic matrix.

26. The method of claim 25, wherein the infiltrating ceramic forming polymer is chosen from the group comprising: a silicon carbide forming polymer, silicon nitride forming polymer, silicon nitrocarbide (SiNC) forming polymer, silicon carbonitride (SiCN) forming polymer and silicon oxycarbide forming polymer.

27. The method of claim 1, further comprising the step of increasing the density of the ceramic composite by infiltrating with one of a carbon forming material and molten silicon or other molten metal such as aluminum or titanium.

28. The method of claim 1, further comprising the step of increasing the density of the ceramic composite by chemical vapor infiltrating with one of carbon, graphite and silicon carbide.

29. The method of claim 1, wherein the coating step includes one of spraying, dipping, soaking and vacuum infiltrating the non-cyclic ceramic forming polymer onto the fiber material.

30. The method of claim 1, wherein the fiber material is one of: a fiber tow, a fiber cloth, a woven fiber preform, a chopped fiber preform, a chopped fiber felt, fiber whiskers, fiber filaments and a particulate.

31. A ceramic composite comprising:
a fiber material; and
a ceramic coating over the fiber material, the ceramic coating formed from a non-cyclic ceramic forming polymer.

32. The ceramic composite of claim 31, wherein the non-cyclic ceramic forming polymer is selected from the group comprising: polycarbosilane, hydridopolycarbosilane, polyhydridosilane, polyhyridosilazane, polysiloxane, polysesquilsiloxane and high char yield hydrocarbon polymer.

33. The ceramic composite of claim 32, wherein the non-cyclic ceramic forming polymer includes carbon, silicon and oxygen.

34. A method of forming a ceramic composite, the method comprising the steps of:
providing a fiber material;
coating the fiber material with a ceramic forming polymer including carbon, silicon and oxygen; and
curing the ceramic forming polymer.

35. The method of claim 34, wherein the ceramic forming polymer is a non-cyclic ceramic forming polymer.

36. A ceramic composite comprising:
a fiber base material; and
a ceramic coating formed from a ceramic forming polymer including carbon, silicon and oxygen.
